(19) United States
(12) Patent Application Publication
(10) Pub. No.: US 2009/0120864 A1
(43) Pub. Date: May 14, 2009

(54) WEARABLE DIALYSIS METHODS AND DEVICES

(76) Inventors: Barry Neil Fulkerson, Longmont, CO (US); Russell T. Joseph, Las Flores, FL (US)

Correspondence Address: PATENTMETRIX, 14252 CULVER DR. BOX 914, IRVINE, CA, 92604, US

(21) Appl. No.: 12/245,397

(22) Filed: Oct. 3, 2008

Related U.S. Application Data
(60) Provisional application No. 60/977,662, filed on Oct. 5, 2007.

(51) Int. Cl. B01D 61/24

(52) U.S. Cl. 210/198.1; 210/321.71; 210/241

(57) ABSTRACT

The present invention provides a portable continuous dialysis system configured as a wearable belt in fluid communication with a separate portable unit in the form of an easy to carry bag-pack or case, or a fanny pack wearable around the shoulder. In one embodiment, the wearable belt unit comprises a dialyzer and a pump, such as a dual pulsatile pump, while the portable unit comprises a dialysate regeneration system and a waste collection bag. In another embodiment, the wearable belt unit comprises a manifold for blood circuit, while the portable unit comprises a manifold for dialysate circuit. The placement of components can be varied between the portable unit and the wearable belt unit, depending upon factors such as comparative weight and size of the belt and portable units, the ease of operation of the dialysis system by the patient, the overall length of the tubing system and the safety of operation of the overall system.

### CROSS REFERENCE

The present invention relies on U.S. Provisional Application No. 60/977,662, filed on Oct. 5, 2007, for priority. Further, the present application incorporates by reference co-pending U.S. patent application Ser. Nos. 12/237,914, filed on Sep. 25, 2008, 12/238,055, filed on Sep. 25, 2008, and 12/210,080, filed on Sep. 12, 2008.

### FIELD OF THE INVENTION

The present invention generally relates to the field of dialysis, and more specifically to a dialysis system that is configured in the form of a portable system, such as a wearable belt in fluid communication with a separate portable unit in the form of an easy to carry bag-pack or case.

### BACKGROUND OF THE INVENTION

Prior art dialysis systems typically comprise a blood circulation circuit comprising a dialyzer and a blood pump and a dialysate circulation circuit. Such conventional dialysis systems however are bulky and typically fixedly mounted on the floor (though portable from one location to another) during dialysis thereby limiting the mobility of a patient for several hours.

U.S. Pat. No. 6,579,253 granted to Burbank et al describes a hemofiltration machine. FIG. 2 of the '253 patent shows a representative embodiment of a machine capable of performing frequent hemofiltration. The machine includes a chassis panel and a panel door that moves on a pair of rails in a path toward and away from the chassis panel. A slot is formed between the chassis panel and the door. FIGS. 3 and 4 of the '253 patent show that when the door is positioned away from the panel, the operator can, in a vertical motion, move a fluid processing cartridge into the slot and, in a horizontal motion, fit the cartridge onto a raised portion of the chassis panel. When properly oriented, the fluid processing cartridge rests on the rails to help position the cartridge. As FIG. 5 shows, movement of the door toward the panel engages and further supports the cartridge for use on the panel for use. The machine preferably includes a latching mechanism and a sensor to secure the door and cartridge against movement before enabling circulation of fluid through the cartridge. The processing cartridge provides the blood and fluid interface for the machine. The machine pumps blood from the person, through the fluid processing cartridge to a hemofilter, back to the cartridge, and then back to the person.

In U.S. Pat. No. 7,004,924 granted to Brugger et al “Systems according to the present invention comprise a pump, a processing unit, a blood draw line, a blood return line, an external flow detector which may be positioned over an exterior surface of the blood return line, and a control unit. The pump is of a type generally described above, preferably being a positive displacement pump, and more preferably being a peristaltic pump. The processing unit may be a conventional hemodialysis, hemofiltration, hemodifiltration, or apheresis unit. The blood draw and return lines will typically comprise catheters which are connectable in the system. In particular, the blood draw line will be connectable between the patient and the pump, while the blood return line will be connectable between the processing unit and the patient. The control unit is preferably a microprocessor and is connectable to both the pump and the flow detector so that the control unit can monitor flow and control pump speed according to the methods described above.”

Prior art systems also exist where the entire dialysis system including the blood circulation and the dialyzing liquid circulation sections are configured to be mounted on a wearable belt device. While such systems do allow patient mobility, these are complex and bulky since both sections of the dialysis system have to be integrated into a single wearable device. Furthermore, prior art systems are not designed to optimally remove toxins from blood, while still maintaining operational efficiency.

Accordingly, there is need for a highly portable dialysis system comprising a relatively lightweight wearable unit, in fluid communication with an easy to carry yet sturdy portable unit. To overcome the drawbacks of prior art, there is also need to enable decoupling and re-coupling of the wearable unit from and with the portable unit in the dialysis system. Also required is an efficient and fail safe fluid flow management in the dialysis system.

### SUMMARY OF THE INVENTION

It is an objective of the present invention to provide a highly portable dialysis system that allows optimal flexibility to a patient to be mobile while going through a dialysis treatment.

In accordance with one objective of the present invention a continuous dialysis system comprises a comparatively light wearable belt unit in fluid communication with a comparatively heavier, sturdy and yet easy to handle and carry portable unit.

In accordance with another objective the portable unit of the present invention is in the form of an easy-to-carry bag-pack or case with a handle. Alternatively, the portable unit is in the form of a fanny pack or a pack that a patient can wear around his shoulder.

Accordingly, in one embodiment, the wearable belt unit comprises a dialyzer and a pump, such as a dual pulsatile pump, that circulates blood and dialysate through the dialysis system of the present invention. The portable unit comprises a dialysate regeneration system and a waste collection bag in one embodiment. In an alternate embodiment the waste collection bag is integrated with the belt unit instead of being contained in the portable unit. Also, a volumetric pump is included for periodic removal of waste fluids into the waste collection bag.

In one embodiment the belt unit is fixedly connected to the portable unit via dialysate inlet and outlet tubes. In a second embodiment the dialysate inlet and outlet tubes have couplings such that the tubes can be coupled or de-coupled thereby allowing the belt unit to be disconnected from the portable unit.

Another embodiment uses two pumps, a first blood pulsatile pump interposed in the blood circuit manifold and a second dialysate pulsatile pump in the dialysate circuit manifold. According to an aspect of the invention the two pulsatile pumps operate 180 degrees out of phase with one another.

The dialysis system of the present invention also comprises a plurality of additional systems and sensing probes that improve the overall quality, efficiency and safety of use of the system. In one example, added systems comprise anti-coagulant pumps and reservoir arrangement for adding an anti-coagulant in blood stream as well as electrolytic pump and reservoir arrangement for adding suitable electrolytes to the dialysate fluid.

Also included in the belt unit is an electronic control unit comprising of a microprocessor that is in electrical communication with the pulsatile pump and other auxiliary pumps such as the anti-coagulant, electrolytic and volumetric pumps. The microprocessor is also in electrical communication with a plurality of sensing probes such as blood-leak detection, bubble detection and flowmeters.

In one embodiment, the present invention is a system for conducting renal dialysis, the system comprising a wearable belt unit comprising a dialyzer and means for circulating blood and dialysate through said system; and a portable unit comprising a dialysate regeneration system, wherein said wearable belt unit is in fluid communication with said portable unit. Optionally, the means for circulating blood and dialysate includes a dual pulsatile pump. The means for circulating blood and dialysate includes a first pulsatile pump for circulating blood and a second pulsatile pump for circulating dialysate. The first pulsatile pump and said second pulsatile pump operate 180 degrees out of phase with one another. The system further comprises a waste collection bag and a volumetric pump for removal of waste fluids into said waste collection bag. The system further comprises a waste collection bag and a volumetric pump for removal of waste fluids into said waste collection bag. The system further comprises arrangements for adding an anti-coagulant to the blood stream and for adding electrolytes to the dialysate. The system further comprises an electronic control unit to control the operation of all the components of said system. The electronic control unit is in electrical communication with a plurality of sensing probes including those for blood-leak detection, bubble detection and flowmeters. One or more of the waste collection bag and volumetric pumps, arrangements for adding anti-coagulant and electrolytes, electronic control unit and sensing probes are contained in the portable unit and one or more of the waste collection bags and volumetric pumps, the arrangements for adding anti-coagulant and electrolytes, the electronic control unit and sensing probes are integrated with the wearable belt unit.

Optionally, the wearable belt unit is fixedly connected to the portable unit. The wearable belt unit is detachably connected to the portable unit. The portable unit is configured in the form of any one of a fanny pack, a case with a handle, or a pack wearable around the shoulder.

In another embodiment, the present invention is directed to a system for conducting renal dialysis, the system comprising a dialyzer, a wearable belt unit comprising a manifold for blood circuit, and a portable unit comprising a manifold for dialysate circuit, wherein said blood circuit is in fluid communication with said dialysate circuit. Optionally, the dialysate circuit includes a dialysate regeneration system and a waste collection system. The dialysate regeneration system comprises a plurality of sorbent cartridges. The blood and fluid flow paths are molded into said manifolds. The manifolds are detachably coupled to each other and to said dialyzer. The disposable components include the dialyzer and the sorbent cartridges. The portable unit is configured in the form of a pack wearable around the shoulder.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 provides a schematic diagram of one embodiment of the dialysis system of the present invention that uses a single dual-channel pulsatile pump;

FIG. 2 shows a second embodiment of the dialysis system of the present invention where the belt and portable units are reversibly detachable from one another;

FIG. 3 provides a schematic diagram of another embodiment of the dialysis system of the present invention that uses a manifold to connect separate blood and dialysate circuits and two separate pulsatile pumps along with requisite subsystems such as sensors, valves and the like;

FIG. 4 shows, in an embodiment, the use of sterile dialysate that is directly infused and then recycled;

FIG. 5 shows blood and dialysate manifolds for use in the dialysis system of the present invention; and

FIGS. 6a through 6c depict how the dialysis system of the present invention can be configured and used by a patient.

### DETAILED DESCRIPTION OF THE INVENTION

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present invention overcomes the drawbacks of the prior art systems by separating the dialyzer and pump, such as a dual channel pulsatile pump, in one embodiment, into a light wearable unit and keeping the relatively bulkier dialysate regeneration and waste collection system in another portable unit.

The present invention also describes novel blood and dialysate circuit manifolds that can be coupled and de-coupled with each other and a dialyzer. Novel flow layouts of the present invention provide efficient and fail safe fluid flow management in the dialysis system.

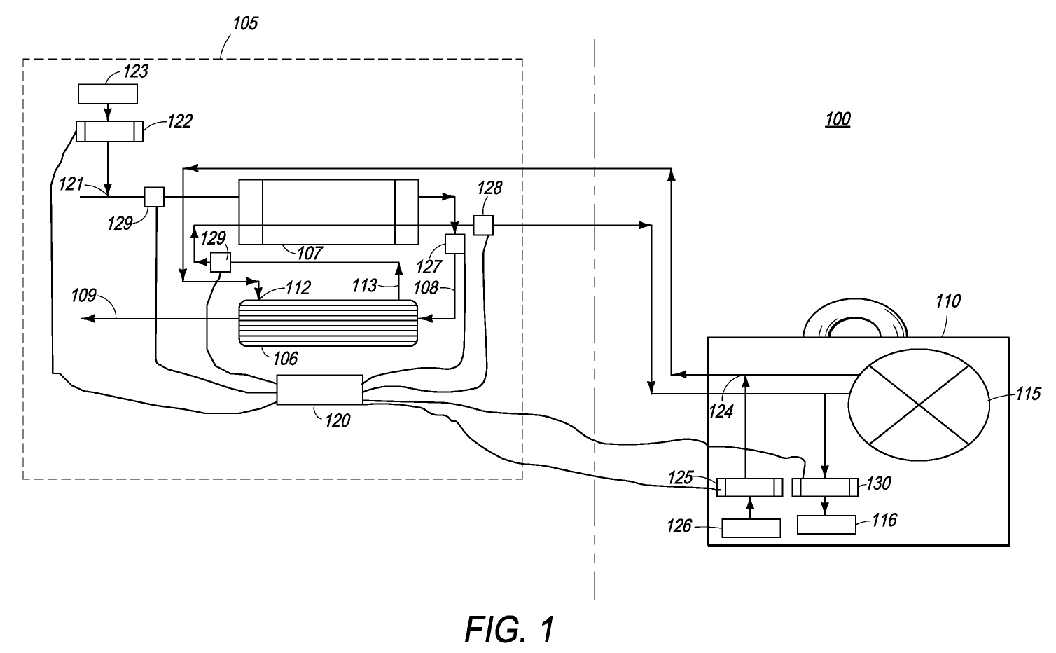

FIG. 1 shows a continuous use dialysis system 100 that in accordance with the present invention comprises a lightweight, wearable belt unit 105 in fluid communication with a comparatively heavier and sturdy portable unit 110 and an electronic control unit 120 that includes a microprocessor and batteries to power the system 100. The wearable belt unit 105 includes a dialyzer 106 and a pump, such as a dual channel pulsatile pump 107, which propels both blood and dialysate through the dialysis system 100. The portable unit 110 supports a dialysate regeneration system 115 and a dialysis waste collector 116, such as a bag or container, and is configured in the form of an easy-to-carry bag, pack or case with a handle such that any person and/or the patient himself can easily carry it along with him while being mobile.

The dialyzer 106 comprises a blood inlet port that receives a flexible blood inlet tube 108 leading from a first blood vessel of a patient and a dialyzed blood outlet port from which extends a flexible dialyzed blood outlet tube 109 leading to a second blood vessel of a patient. The dialyzer 106 also comprises a regenerated dialysate inlet port that receives a flexible dialysate inlet tube 112 from the dialysate regeneration system 115 and a spent dialysate outlet port from which extends another flexible spent dialysate outlet tube 113 leading back to the dialysate regeneration system 115 and also to the waste collection bag 116 through a volumetric pump 130. The pulsatile pump 107 is interposed in the impure blood inlet tube 108 and the spent dialysate outlet tube 113 as shown.

Thus, according to one embodiment the wearable belt unit 105 and the portable unit 110 are connected to each other constantly via the dialysate inlet and outlet tubes 112 and 113. In this embodiment, the two units 105 and 110 are not easily detachable from one another. If the patient needs to be mobile, he can carry the portable unit 110 while the belt unit 105 is worn on his body.

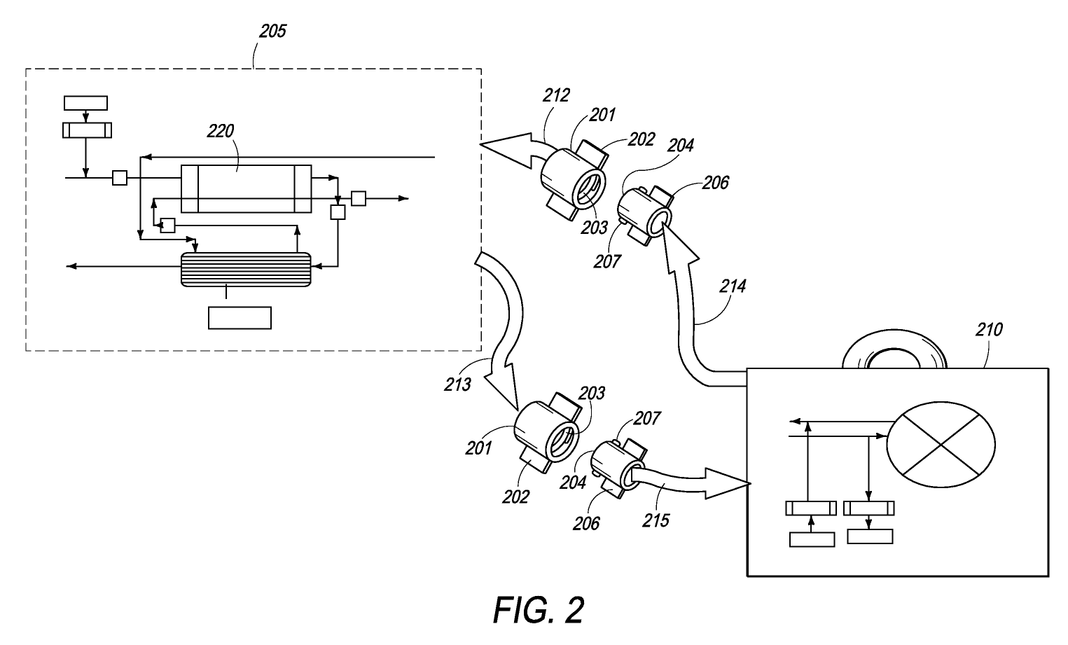

In a second embodiment, the two units are detachable from each other, allowing further flexibility and mobility to the patient. In the second embodiment the flexible dialysate inlet and outlet tubes 112, 113 can be coupled or decoupled as required. FIG. 2 depicts dialysate inlet and outlet tubes 212, 213 which are not continuous; rather, each tube emanates from the belt unit 205 and terminates within a coupling device 201 that includes a rigid tube from which radially extend a pair of gripping ears 202 and a pair of diametrically opposed coupling slots 203 formed in the inner surface. Similarly, the mating coupling devices 204 of each corresponding dialysate inlet and outlet tube 214, 215, emanating from the portable unit 210, includes a rigid tube with a pair of gripping ears 206 extending radially therefrom. Also, extending from the couple is a pair of diametrically opposed coupling protrusions 207. Thus, the coupling devices of the dialysate inlet and outlet tubes emanating from the belt unit are adapted for leak-tight coupling with the corresponding couples of the dialysate inlet and outlet tubes emanating from the portable unit.

Under normal operating conditions, the belt unit 205 is coupled to portable unit 210 via the connecting couples as shown in FIG. 2. Thus, in this condition, purification of blood can be carried out. If, during the course of this operation, the patient moves away from portable unit 210, the belt unit 205 is decoupled from the portable unit 210 and the patient can leave while wearing the belt. At that time, the patient remains connected to the dialyzer and the circulation of the blood is continued by the pulsatile pump. Thereafter, when the patient has returned to the original location, the belt unit 205 is again coupled to the portable unit 210, and thus the apparatus is returned to its operational condition and the medical treatment of the patient is resumed.

To detect the coupling and decoupling of the belt unit 205 with/from the portable unit 210, the electronic control unit 120 of FIG. 1 includes a disconnect sensor and a timer. Such disconnect sensors and timers are well known to persons of ordinary skill in the art. Exemplary sensors include alarm units manufactured by Redsense Medical, magnetic sensors, and Hall effects sensors. As soon as the belt unit 205 is decoupled from the portable unit 210 the disconnect sensor is tripped and a disconnect signal is sent to the microprocessor. This results in the microprocessor disabling dialysate pumping by the dual channel pulsatile pump 220. At the same time the microprocessor starts an electronic timer to keep track of the time for which the belt unit 205 remained decoupled from the portable unit 210. After lapse of a predetermined amount of time, e.g. 1 to 72 hours, the microprocessor signals an alarm/alert to the patient conveying that the patient needs to connect the belt unit to the portable unit. This alarm can be audio and/or visual via suitable buzzers and/or LEDs as would be evident to persons of ordinary skill in the art. Thus, the patient can move at will, while wearing the belt, which eliminates the disadvantage that the patient is bound to a fixed position for a long time.

Referring back to FIG. 1, during dialysis, the dual channel pulsatile pump 107 pumps blood into the blood inlet tube 108 and through the dialyzer 106 in one direction, while it pumps the dialysate in a direction opposite to that of the blood flow. The flow directions are indicated by arrows in FIG. 1. Spent dialysate flows towards the dialysate regeneration system 115 of the portable unit 110 through the spent dialysate tube 113. Excess fluid is removed from the spent dialysate in the spent dialysate tube 113 through the volumetric pump 130 and into the waste collection bag 116, which is periodically emptied by the patient via an outlet such as a tap. The microprocessor in the electronic control unit 120 determines the rate and amount of fluid removal through volumetric pump 155.

In one embodiment the dialyzer 106 comprises a plurality of miniaturized dialyzers that use the dialysate to remove impurities from the patient's blood. The dialyzers are known to persons of ordinary skill in the art and the actual number of miniaturized dialyzers used depends upon the dialysis prescription for the patient. Also, these pluralities of dialyzers may be connected in series or in parallel in different embodiments.

Similarly, the dialysate regeneration system 115 comprises a plurality of cartridges and/or filters containing sorbents for regenerating the spent dialysate. By regenerating the dialysate with sorbent cartridges, the dialysis system 100 of the present invention requires only a small fraction of the amount of dialysate of a single-pass hemodialysis device. In one embodiment, each sorbent cartridge is a miniaturized cartridge containing a distinct sorbent. For example, a system of five sorbent cartridges may be used wherein each cartridge separately contains urease, zirconium phosphate, hydrous zirconium oxide and activated carbon. In a second embodiment each cartridge may comprise a plurality of layers of sorbents described above and there may be a plurality of such separate layered cartridges connected to each other in series or parallel. Persons of ordinary skill in the art would appreciate that urease, zirconium phosphate, hydrous zirconium oxide and activated carbon are not the only chemicals that could be used as sorbents in the present invention. In fact, any number of additional or alternative sorbents could be employed without departing from the scope of the present invention.

The dialysis system 100 of the present invention also incorporates a plurality of additional systems that further enhance the quality, efficiency and effectiveness of the system. For example, with reference to FIG. 1, the blood inlet tube 108 includes a side port 121 through which an anticoagulant, such as heparin, is pumped into the blood stream by an anticoagulant pump 122 from an anticoagulant reservoir 123. Other anticoagulants known to persons of ordinary skill in the art include prostacyclin, low molecular weight heparin, hirudin and sodium citrate. Within the portable unit 110, the regenerated diaysate tube 112 emanating from the dialysate regeneration system 115 also includes a side port 124 through which electrolytes are pumped into the dialysate stream by another electrolytic pump 125. The electrolytes are contained in an electrolyte reservoir 126 enclosed within the portable unit 110.

Each additive micro-pump 122, 125 forces a controlled amount of a respective additive into the blood and the dialysate respectively, wherein the rate of infusion of each additive is controlled electronically by the microprocessor in the electronic control section 120. In a known manner, a physician can use the electronic control section 120 to set the rate of infusion for each additive to correspond to a predetermined dose for each additive. Typical additives include, but are not limited to, sodium citrate, calcium, potassium and sodium bicarbonate.

The microprocessor of the electronic control unit 120 controls various aspects of the dialysis system 100 of the present invention. One of the several functions of the microprocessor is to monitor the batteries that are rechargeable while remaining in the wearable belt unit 105. The microprocessor monitors the charge status of the batteries and if it determines that the batteries are low on charge or less than a preset amount, such as an hours charge left, triggers an alarm via an alarm circuit. The alarm may be audio and/or visual using liquid crystal or LED displays.

A plurality of sensor devices is also in electrical communication with the microprocessor of the electronic control unit 120. These sensor devices enable continuous monitoring of various aspects for a safe and efficient functioning of the dialysis system 100. For example, a bubble-detecting probe 127 is interposed in the blood inlet tube 108 before it enters the blood inlet port of the dialyzer 106. A blood-leak-detecting probe 128 is interposed in the spent dialysate outlet tube 113. Flowmeters 129 are also interposed in the blood inlet tube 108 and the spent dialysate outlet tube 113 to substantially continuously measure blood and dialysate flow rates. The probes 127, 128 and flowmeters 129 are in electrical communication with the microprocessor such that they regularly send sensed signals that are compared at the microprocessor with predetermined or pre-set threshold values to determine an alarm situation. Such probes, flowmeters and the use thereof for monitoring various aspects of the dialysis system are known to persons of ordinary skill in the art and are therefore not described here in further detail.

In alternate embodiments, the volumetric pump 130 and the waste bag 116 are integrated in the belt unit 105 instead of being contained in the portable unit 110 as otherwise described with respect to the embodiment of FIG. 1. In another example, the electronic control unit 120 along with batteries is contained within the portable unit 110 of FIG. 1 thereby further reducing the weight and size of the wearable belt unit 105. What additive systems and sensor probes should be integrated into the belt unit 105 and which ones should be contained within the portable unit 110 can be varied depending upon factors such as comparative weight and size of the belt and portable units, the ease of operation of the dialysis system by the patient, the need to keep the overall length of the tubing system short to reduce fluctuations of the blood temperature outside the patient's body and the safety of operation of the overall system. All such variations in the combination of various systems of the dialysis device into the belt and the portable unit are within the scope of the present invention.

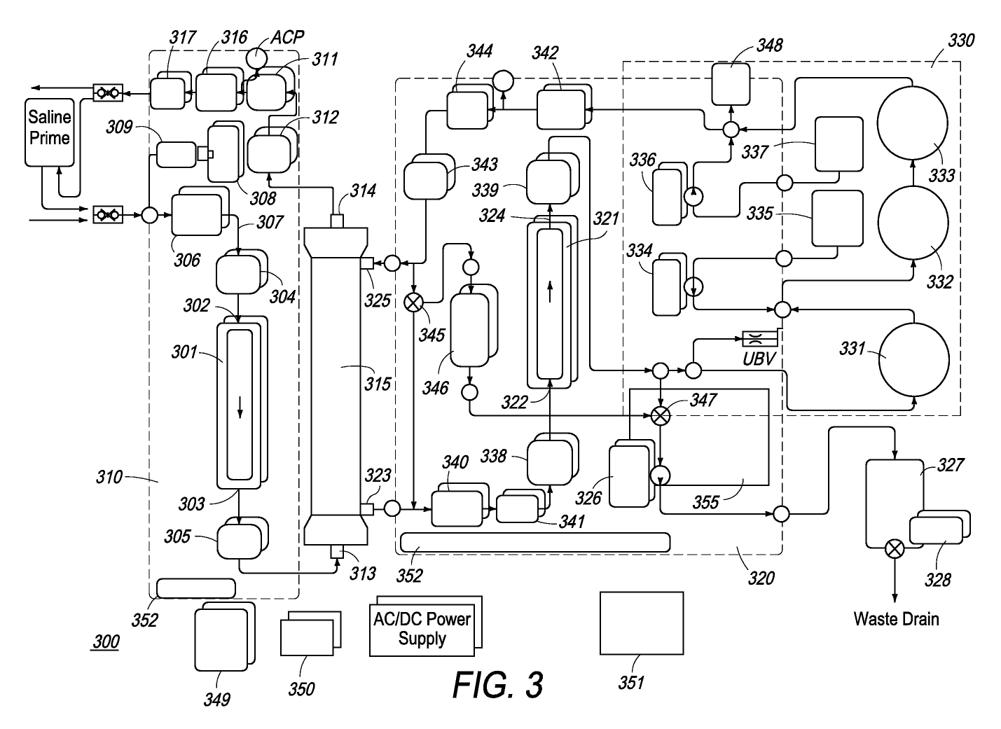

FIG. 3 shows another embodiment of the dialysis system 300 of the present invention. The system 300 comprises a blood circuit manifold 310 detachably connected to, and in fluid communication with, a dialysate circuit manifold 320. The blood circuit manifold 310 is configured in the form of belt structure that can be worn by a patient. The blood circuit manifold 310 comprises a blood pulsatile pump 301, the outlet port 303 of which is connected to the blood inlet port 313 of a dialyzer 315. The pulsatile pump 301 receives blood from a vessel of a patient, at its inlet port 302, and impels the blood through the dialyzer 315. The dialyzer 315 purifies the blood through an osmotic and convective exchange of impurities between the blood and dialysate via a trans-membrane. The purified blood flowing out of the dialyzer 315 is driven back, by the pulsatile pump 301, into a vessel of the patient. It should be appreciated that, although not preferred, manifolds can be replaced with tubing in the absence of a supporting manifold structure.

A plurality of sensing devices is also advantageously incorporated into the blood circuit 310. The inlet and outlet blood pressure sensors 304, 305 are interposed into the blood channels such that they monitor blood pressure before blood enters the pump 301 at its blood inlet port 302 as well as the blood pressure at the blood outlet port 303 of the pump 301. An ultrasonic flowmeter 306 interposed in the blood supply line 307 upstream from the inlet blood pressure sensor 304 monitors and assists in maintaining a predetermined rate of flow of blood in the blood circuit manifold 310. A heparin micropump 308 pushes a regulated and predetermined quantity of heparin from a heparin reservoir 309 into the blood supply line 307 via a side port. As described earlier in this specification heparin acts as an anti-coagulant. Persons of ordinary skill in the art would realize that suitable anti-coagulants other than heparin can also be used.

Purified blood exiting from the blood outlet port 314 of the dialyzer 315 is monitored by a venous blood pressure sensor 312, a blood temperature sensor 311 and an air-in-line sensor 316 while being pumped back into the patient via a pinch return valve 317. The blood pressure sensors 304, 305 and 312 ensure that a regulated amount of pressure gradient is maintained throughout the blood circuit manifold 301. The blood temperature sensor 311 monitors and controls temperature of blood being driven back into the patient such that it is close to the required body temperature of the patient. The air-in-line sensor 316 detects air traps in the return blood line 318.

Preferably, the dialysate circuit 320 of the present invention is configured in the form of a fanny pack/bag structure. The dialysate circuit 320 comprises a dialysate pulsatile pump 321, the inlet port 322 of which is connected to the dialysate output port 323 of the dialyzer 315. The dialysate pulsatile pump 321 receives spent dialysate, from the dialyzer 315, at its inlet port 322 and pumps the dialysate through a dialysate regeneration module 330 back into the dialyzer 315. A waste micro-pump 326 drives waste from the spent dialysate, being pumped out of the dialysate pump 321 and on its way to the regeneration module 330, into a waste collection reservoir 327. The waste collection reservoir 327 is periodically drained through an automated or manually operated outlet (such as a tap) when sensor 328 senses/indicates that the waste collection reservoir 327 is full.

The dialysate regeneration module 330 comprises a plurality of sorbent cartridges. In one embodiment, the module comprises three sorbent cartridges—a first urease, zirconium phosphate cartridge 331, a second zirconium phosphate/zirconium hydroxide cartridge 332 and a third activated carbon cartridge 333. The spent dialysate is driven by the pulsatile pump 321 through the three cartridges one after another. The sorbent cartridges cleanse the spent dialysate of impurities and regenerate the dialysate as the dialysate flows past the cartridges. As part of the regeneration process the dialysate is also primed with suitable additives. In the present embodiment additives such as sodium bicarbonate as well as electrolytes are pumped into the dialysate as it flows through the cartridges. A bicarbonate micro-pump 334 pushes sodium bicarbonate, contained in a reservoir 335, into the flowing dialysate. Similarly, an electrolyte micro-pump 336 drives electrolytic infusate, from an infusate reservoir 337, into the flowing dialysate.

A plurality of sensory devices is also advantageously incorporated into the dialysate circuit 320. The inlet and outlet dialysate pressure sensors 338, 339 are interposed into the dialysate channels such that they monitor dialysate pressure before spent dialysate enters the pump 321 at its dialysate inlet port 322 as well as the dialysate pressure at the dialysate outlet port 324 of the pump 321. An ultrasonic flow meter 340 interposed in the spent dialysate supply line upstream from the inlet dialysate pressure sensor 338 monitors and helps maintain a predetermined rate of flow of dialysate in the dialysate circuit manifold 320. A blood leak sensor 341 is also interposed in the dialysate supply line that detects and alerts leakage of blood due to tearing or rupture of the trans-membrane of the dialyzer 315.

Regenerated and clean dialysate, on its way back to the dialyzer 315, is further monitored for conductivity and temperature using conductivity and temperature sensors 342, 343. Thus, if the temperature of the dialysate flowing into the dialyzer 315 is below a predetermined value, the main controller board 351 activates the heating plate 355 against the dialysate circuit manifold 320. An air-in-line sensor 344 is also interposed in the dialysate return line. A dialyzer bypass valve 345 is also positioned in the dialysate return line close to the dialysate inlet port 325 of the dialyzer 315. An ion sensor 346 monitors the regenerated dialysate for concentration of various ions such as sodium, potassium, calcium, hydroxyls as well as its pH. In case of higher concentration of such ions, the sensor 346 actuates the bypass valve 345 to divert amounts of the regenerated dialysate back into the regeneration module 330. Additionally or alternatively, the sensor 346 can also actuate an ion sensor selector valve 347 to drain the dialyste into the waste collection reservoir 327.

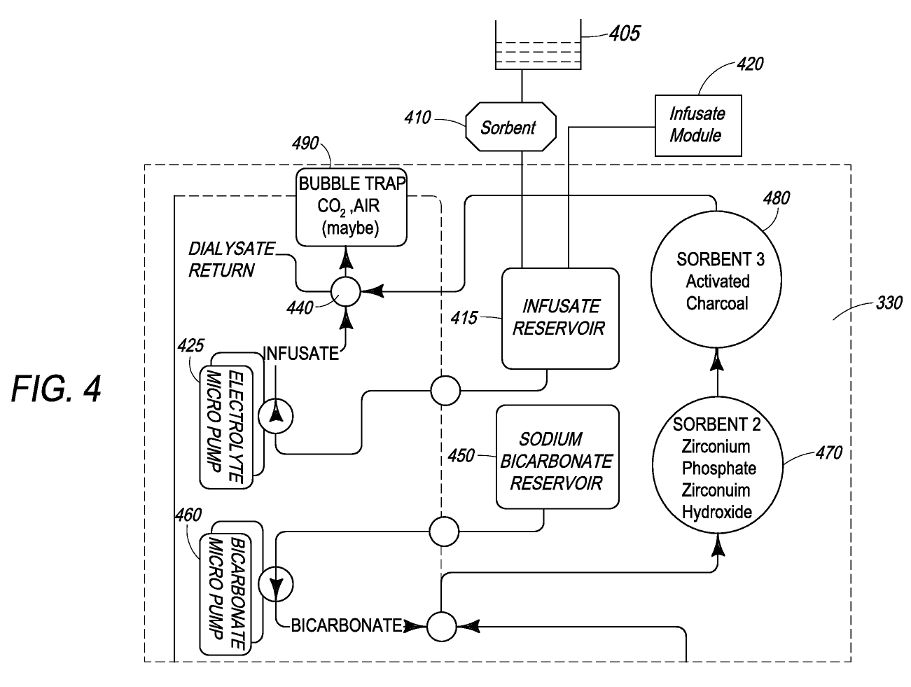

While the current embodiment cleanses and regenerates spent dialysate using the dialysate regeneration module 330, in an alternate embodiment sterile dialysate is directly infused into the dialysate circuit 320 and then recycled. FIG. 4 depicts a portion of the dialysate regeneration module 330 of FIG. 3, where non-sterile water from a source 405 passes through a sorbent module 410 and into the infusate reservoir 415. Also connected to the infusate reservoir 415 is an infusate module 420 that is the source of the infusates such as minerals, vitamins, medicines, etc. These infusates are mixed with the water in the infusate reservoir 415 and injected directly into the sterile dialysate fluid stream 440 via an electrolyte micro-pump 425. The dialysate fluid stream preferably passes through a series of treatments, including a bicarbonate treatment using sodium bicarbonate from a reservoir 450 pumped using a micro pump 460, a first sorbent pass (in the form of a cartridge with zirconium phosphate/zirconium hydroxide) 470, a second sorbent pass (in the form of the same or separate cartridge with activated carbon) 480, and a trap for air/CO₂ bubbles 490.

In conventional dialysis machines, CO₂ emissions do not pose a functional problem, because emissions are released to the atmosphere. Due to the dialysate-closed-circuit configuration of the present invention, the chemically generated CO₂ creates bubbles that lead to a mechanical obstruction, thus causing a substantial drop in the dialysate flow. Urea and other toxins are extracted from the blood in the dialyzer, entering the dialysate and into the powder-filled sorbent cartridges 331, 332, 333. As described earlier, the dialysate is subsequently regenerated via its passage through a series of three sorbent cartridges filled with various powders in pre-determined quantity ratios, the cartridges including a urease and zirconium phosphate cartridge, a zirconium phosphate and hydroxyl zirconium oxide cartridge, and an activated carbon cartridge.

Hardware circuit boards for flow sensors 349, battery backup pack 350 and the microprocessor controller 351 for managing the plurality of sensors (including wireless sensors 352 for wireless communication to a hospital or patient care personnel in the event of any component/system malfunction in the blood and/or dialysate circuit manifold), pulsatile pumps 301, 321 and functioning of the dialysis system 300 should be readily evident to persons of ordinary skill in the art.

System 300 uses two pulsatile pumps, a first pulsatile pump 301 for the blood circuit 310 and a second pulsatile pump 321 for the dialysate circuit 320. Prior art dialysis machines generate steady flow in both the blood circuit and the dialysate circuit. Some prior art dialysis machines use pulsatile flow in the blood circuit to more closely mimic the flow generated by a healthy heart but use steady flow in the dialysate circuit. In accordance with a novel feature the dialysis system 300 of the present invention uses pulsatile flow in both circuits 310, 320 and runs the two pulsatile pumps 180 degrees out of phase so that the blood circuit pressure reaches a maximum when the dialysate circuit pressure reaches a minimum and vice versa. This pressure waveform periodically increases the trans-membrane pressure gradient in the dialyzer which adds convective mass transfer forces to drive fluid and waste exchange. Persons of ordinary skill in the art would appreciate the benefits of the out of phase pulsation technique comprise: increased clearance by convective mass transfer; reduced clotting by the more physiologic blood circuit flow pattern; increased dialyzer life because the pores are periodically cleansed by changing convection gradients; and the ability to clear toxins not typically cleared, such as β-2 microglobulin (β2M) or p-cresol.

Another novel aspect of the present embodiment is the use of lower overall dialysate fluid volumes. Conventional single pass dialysis systems require 30 to 50 liters of dialysate fluid per treatment. Other prior art sorbent based dialysis systems are known to require about 6 liters of recirculated dialysate fluid but at conventional high flow rates. The present invention uses less than 1 liter of recirculated dialysate fluid, more preferably ½ liters, at lower flow rates and therefore longer treatment time. Persons of ordinary skill in the art would appreciate that the low dialysate fluid use further reduces the overall size and weight of the dialysis system of the present invention. An additional advantage of the use of such low volumes of the dialysate fluid is that sterile dialysate can be more economically provided for treatments.

Conventional single pass machines remove metabolic products and toxins from blood by diffusion (osmosis) across a semi permeable membrane and do not permit the non-sterile dialysate to pass back into the patient. In accordance with an important aspect the dialysis system of the present invention low dialysate flow rates result in the use of low dialyate fluid volumes enabling removal of metabolic products and toxins by a combination of diffusion and convection (diafiltration) resulting in economical sterile dialysate while permitting some of the sterile dialysate to flow back to the patient. FIG. 4 shows the direct input of sterile dialysate from the infusate reservoir 415, which is generated by sending a water source 405 through a sorbent cartridge 410 and an infusate source 420, into the clean dialysate return stream. The water in water source 405 need not be purified and, in fact, can be obtained directly from a typical tap water source. Additionally, the low dialysate fluid flow also means that the absolute volume of blood outside the body (in the blood circuit) at any given point in time is minimized. This is beneficial with respect to less blood temperature fluctuations and that the amount of blood cells lost at any point in time is minimized leading to lowered amount of iron supplementation needed.

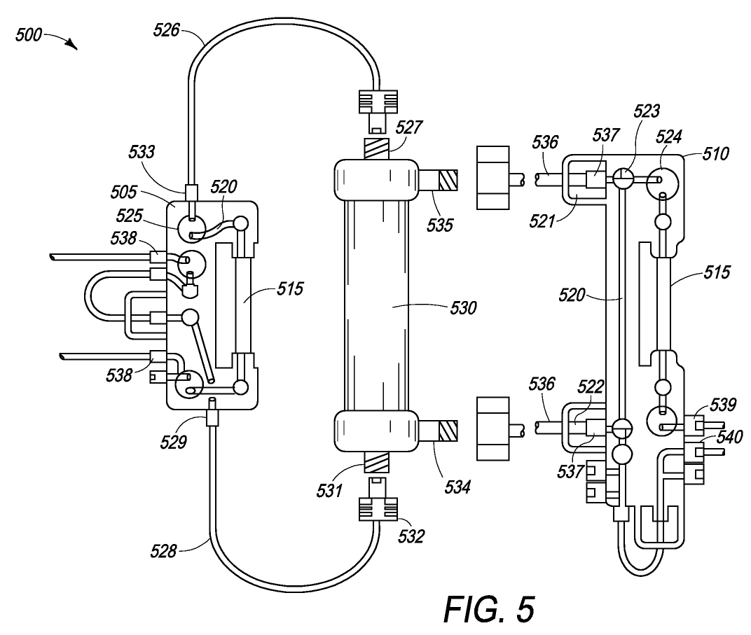

Referring to FIG. 5, a manifold for use in the dialysis system 500 of the present invention is now described. FIG. 5 shows a first manifold 505 for the blood circuit and a second manifold 510 for the dialysate circuit in accordance with one embodiment. The manifolds 505, 510 are bonded or ultrasonically welded and incorporate several components including pump tube segments 515 for liquid flow control, molded fluid flow pathways 520 to the sensors (such as blood-leak 521 and the air-in-line sensors 522), valve components and pressure diaphragms such as the selector valve 523 and diaphragm 524 shown for the dialysate circuit manifold 510. A manifold comprises three parts: a mid-body into which fluid pathways are molded from at least one side; a back cover that seals the valves, pressure diaphragms and any other component interfaces; and a front cover that covers and seals the fluid pathways.

The back cover traps the elastomeric components which are two-shot molded into the back cover. In an alternate embodiment the mid-body has fluid pathways molded on both sides and the front and back covers both contain elastomeric components. The fluid pathways within the manifold end in tubing receptacles for receiving tubing that attaches to other components in the circuit that are required for the process the manifold is intended to perform. The fluid pathways within the manifold end in luer lock fittings that attach to mating luer lock fittings for attaching other circuit components.

The aforementioned pathway constructs are now described specifically with respect to the molded fluid pathway 520 of the blood circuit manifold 505. The pathway 520 ends in a tubing receptacle 525 for receiving the pure blood inlet tube 526 that transfer pure blood from the dialyzer 530 to the blood circuit manifold 505. The pure inlet blood tube 526 attaches to the pure blood outlet port 527 of the dialyzer 530. Fluid pathway 520 within the manifold terminates in luer lock fitting that attach to mating luer lock fitting that receives the pure blood inlet tube 526 external to the manifold 505.

According to an aspect of the present invention the manifolds are constructed to be modular and easily detachable and re-attachable from one another as well as from the disposable dialyzer. As can be seen in FIG. 5, the manifold structures comprise a plurality of built-in ports that are used to attach other components via tubings. For example, the blood outlet tubing 528 connects the dialyzer 530 to the blood circuit manifold 505 at the manifold port 529. The blood outlet tube 528 ends in the form of a luer lock fitting with a mating fitting of the blood inlet port 531 of the dialyzer 530.

The blood inlet port 531 of the dialyzer 530 has suitable screws cut on the outside to allow the nut 532 at the end of the tubing 528 to be secured onto the port 531 for leak less attachment. Similarly, the blood inlet tubing 526 connects the dialyzer 530 to the blood circuit manifold 505 at the manifold port 533. Also, the spent dialysate outlet port 534 and the regenerated dialysate inlet port 535 of the dialyzer 530 can be attached or detached to the dialysate circuit manifold 510 using tubings 536 that at one end lock on to the ports 534, 535 of the dialyzer 530 and at the other fit into to receiving ports 537 of the dialysate circuit manifold 510 structure. Thus, the manifolds 505, 510 as well as the dialyzer 530 can be attached and reattached to one another.

Other examples of the ports constructed as part of the manifold structures are the artery and vein ports 538 in the blood circuit manifold 505 and the dialysate manifold-to-sorbent port 539 and sorbent-to-dialysate manifold port 540 for attaching the dialysate manifold 510 to sorbent cartridges (not shown).

Yet another novel feature of the present embodiment is the advantageous combination and use of disposable and non-disposable components. Referring back to FIG. 3, for example, all elements described earlier with respect to the blood circuit manifold 310, except the dialyzer 315 and the heparin reservoir 309, are non-disposable and therefore fixedly attached/integrated into the belt structure as part of the blood circuit manifold. The dialyzer 315 and the heparin reservoir 309 are however disposable. Again, in the dialysate circuit manifold 320 the bubble-trap installation 348, reservoirs such as those for sodium bicarbonate 335, infusate 337 and waste 327 as well as the three sorbent cartridges 331, 332, 333 are disposable. All other elements described earlier for the dialysate circuit manifold 320 are non-disposable and therefore fixedly attached/integrated into the bag structure as part of the dialysate circuit manifold 320.

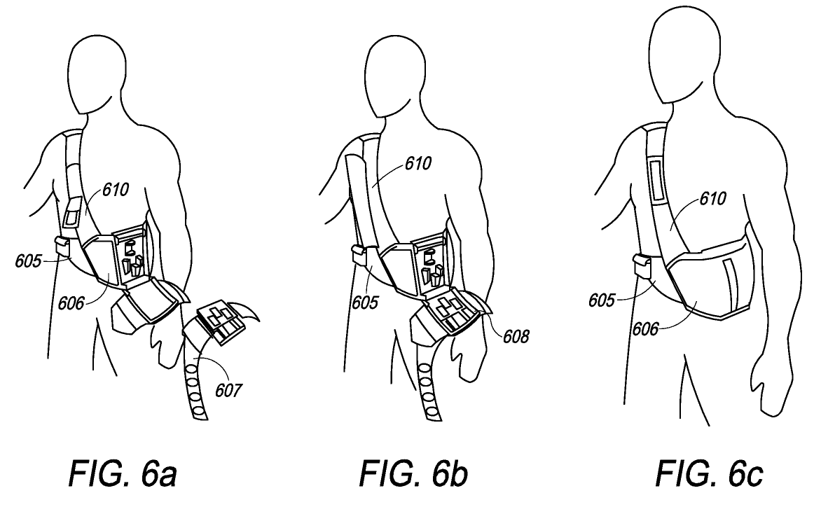

FIGS. 6a through 6c depict ways in which a patient may configure and use the dialysis system of the present invention. These figures also depict an exemplary embodiment of how the disposable and non-disposable elements of the present invention are configured. Referring to FIGS. 6a, 6b and 6c, the blood circuit manifold is configured in the form of a belt 605 that can be worn around the waist, while the dialysate circuit manifold is configured in the form of a fanny pack 610 that can be worn around the shoulder. FIG. 6a also shows the base structure 606 comprising of non-disposable elements of the invention, separated from an insert 607 comprising the disposable components. FIG. 6b shows the disposables insert 607 attached into a receptacle panel 608, positioned such that it can be joined with the base structure. FIG. 6c shows the disposables insert along with the receptacle panel collapsed onto the base structure 606, when the receptacle panel has closed.

While there has been illustrated and described what is at present considered to be a preferred embodiment of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiment disclosed as the best mode contemplated for carrying out the invention, but that the invention will include all embodiments falling within the scope of the appended claims.

We claim:

1. A system for conducting renal dialysis, the system comprising:
a wearable belt unit comprising a dialyzer and means for circulating blood and dialysate through said system; and
a portable unit comprising a dialysate regeneration system,
wherein said wearable belt unit is in fluid communication with said portable unit.

2. The system of claim 1 wherein said means for circulating blood and dialysate include a dual pulsatile pump.

3. The system of claim 1 wherein said means for circulating blood and dialysate include a first pulsatile pump for circulating blood and a second pulsatile pump for circulating dialysate.

4. The system of claim 3 wherein said first pulsatile pump and said second pulsatile pump operate 180 degrees out of phase with one another.

5. The system of claim 3 wherein said system further comprises a waste collection bag and a volumetric pump for removal of waste fluids into said waste collection bag.

6. The system of claim 1 wherein said system further comprises a waste collection bag and a volumetric pump for removal of waste fluids into said waste collection bag.

7. The system of claim 1 wherein said system further comprises arrangements for adding an anti-coagulant to the blood stream and for adding electrolytes to the dialysate.

8. The system of claim 1 further comprising an electronic control unit to control the operation of all the components of said system.

9. The system of claim 8 wherein said electronic control unit is in electrical communication with a plurality of sensing probes including those for blood-leak detection, bubble detection and flowmeters.

10. The system of claim 6 wherein one or more of said waste collection bag and volumetric pump, said arrangements for adding anti-coagulant and electrolytes, said electronic control unit and said sensing probes are contained in the portable unit and one or more of said waste collection bag and volumetric pump, said arrangements for adding anti-coagulant and electrolytes, said electronic control unit and said sensing probes are integrated with the wearable belt unit.

11. The system of claim 1 wherein said wearable belt unit is fixedly connected to said portable unit.

12. The system of claim 1 wherein said wearable belt unit is detachably connected to said portable unit.

13. The system of claim 1 wherein said portable unit is configured in the form of any one of a fanny pack, a case with a handle, or a pack wearable around the shoulder.

14. A system for conducting renal dialysis, the system comprising:
a dialyzer;
a wearable belt unit comprising a manifold for blood circuit; and
a portable unit comprising a manifold for dialysate circuit,
wherein said blood circuit is in fluid communication with said dialysate circuit.

15. The system of claim 14 wherein said dialysate circuit includes a dialysate regeneration system and a waste collection system.

16. The system of claim 15 wherein said dialysate regeneration system comprises a plurality of sorbent cartridges.

17. The system of claim 14 wherein blood and fluid flow paths are molded into said manifolds.

18. The system of claim 14 wherein said manifolds are detachably coupled to each other and to said dialyzer.

19. The system of claim 18 wherein said disposable components include the dialyzer and the sorbent cartridges.

20. The system of claim 14 wherein said portable unit is configured in the form of a pack wearable around the shoulder.
